(19) United States
(12) Patent Application Publication
(10) Pub. No.: US 2009/0268456 A1
(43) Pub. Date: Oct. 29, 2009

(54) High performance luminaire with a lamp and a reflector

(75) Inventors: Andree Mehrtens, Grunenplan (DE); Steffen Korner, Delligsen (DE); Dirk Tedeschi, Northeim (DE); Harry Wagener, Alfeld (DE)

Correspondence Address: DUANE MORRIS LLP - DC, 505 9th Street, Suite 1000, WASHINGTON, DC, 20004-2166, US

(73) Assignee: Auer Lighting GmbH, Bad Gandersheim (DE)

(21) Appl. No.: 12/453,068

(22) Filed: Apr. 28, 2009

(30) Foreign Application Priority Data
Apr. 28, 2008 (DE) 10 2008 021 550.3

(51) Int. Cl. F21V 7/00

(52) U.S. Cl. 362/235

(57) ABSTRACT

A high performance luminaire having at least one lamp (1) and a reflector (2), partially surrounding the lamp (1), for focusing to a directed beam the light emitted by the lamp (1), the reflector (2) having an internal reflecting surface (3) which includes regions with different requirements because of being differently spaced from the lamp (1), permits an optimization of the reflector (2) during an optimization of its production costs by virtue of the fact that the reflector (2) comprises at least a first partial reflector (5) and a second partial reflector (6) which lie next to one another at an abutting edge (11), and whose reflecting surfaces (9, 10) together form the internal reflecting surface (3) of the reflector (2).

The invention relates to a high performance luminaire having at least one lamp and a reflector, partially surrounding the lamp, for focusing to a directed beam the light emitted by the lamp, the reflector having an internal reflecting surface which has regions with different requirements because of being differently spaced from the lamp.

High performance luminaires of the type addressed here are, for example, light sources for digital projection and spotlights for illuminating stages, architecture and the like. Because of the performance of the lamps, for example halogen lamps, but in particular extra high pressure mercury lamps, the reflectors surrounding the lamps reach their thermal loading limit, since the thermal radiation emitted by the lamp is usually proportional to the light output of the lamp. However, since the overall size of the luminaire is not to increase to the same extent as the light output and thermal output that are used, the thermal loading of the reflector per surface unit rises sharply such that critical values relevant to the long term thermal dimensional stability of the reflector body are reached, examples being the transformation temperature, the softening temperature and the nominal mean coefficient of thermal longitudinal expansion. Whereas the transformation temperature and the softening temperature are parameters for the long term thermal dimensional stability of the body, the nominal mean coefficient of thermal longitudinal expansion a reflects the resistance of the body to short term temperature changes.

A type of glass with a low coefficient of longitudinal expansion a suitable for reflectors in general is a borosilicate glass available on the market under the trade name of SUPRAX® (Schott A G, Mainz). However, such types of glass reach their loading limit for the above described uses, and so alternative material must be used.

Particularly suitable as alternative material is glass ceramic which is, in particular, resistant to short term temperature changes such as occur when the luminous means in closed spotlight systems is turned on and off. Consequently, it is preferred in the case of high performance spotlights to use glass ceramic reflectors, which have a substantially higher resistance to temperature changes before thermally induced breakage comes about with them. However, the glass ceramic reflectors have the particular disadvantage of high production costs by contrast with standard reflectors of comparable size and of glass composition such as, for example, SUPRAX®. Moreover, the reflectors produced from glass ceramic have technical disadvantages in the case of the coating of the internal reflector surface when the latter is produced using a coating method such as, in particular, the PICVD (Plasma-Impulse-Chemical-Vapor-Deposition) method, since this method is based on coupling microwaves into the region to be coated. Depending on their state of ceramization, glass ceramics have a clearly varying transparency or a clearly different absorptivity for microwaves. Consequently, the coating parameters, and therefore also the properties, resulting in the course of the coating operation, of the coating, such as transmissivity, optical refractive power and mechanical or chemical properties of the coating—depend strongly on the state of ceramization. Series production is thus very difficult—particularly that of large glass ceramic reflectors with unchanging properties. The coating of the reflector material is of great importance because in many cases it is designed such that it not only retroreflects as much light as possible, but at the same time also passes the thermal radiation of the light source (lamp) through the reflector such that the optical components, such as diffusing lenses or filters, following in the beam path are subjected to much less thermal loading. In order to decouple as much thermal radiation as possible from the reflector, the coating must be designed such that it retroreflects as much light as possible in the visible region from approximately 400 to 700 nm, in order to produce a strong mirror effect, whereas in the wavelength region adjacent thereto (near infrared region) above 700 nm the aim is for as large a fraction as possible of the thermal radiation to traverse the coating. This infrared radiation then usually largely traverses both the coating and the reflector material such that it is coupled directly out of the spotlight system.

Such a coating, which is used for a so-called cold light mirror system, is widespread in the case of stage spotlights and projectors for digital projection (for example cinema projection), and cannot be implemented by a simple metallic coating. Rather, it is necessary to apply a sequence of interference optical alternating layers with different refractive indices. Such interference layer systems are also used for other applications, such as UV protective filters, color conversion filters, bandpass filters, antireflective coatings, etc. and are therefore adequately known. They comprise alternatingly high refractive and low refractive layers that must be adequately transparent in the optical region. Particularly suitable for low refractive layers is silicon dioxide SiO₂, which has a refractive power of approximately 1.45, since it is very transparent and can be subjected to high thermal loads.

It is mostly layers made from titanium dioxide TiO₂ with a refractive power of 2.4 to 2.5 that are used as high refractive layers, although this material is not very resistant to temperature and is frequently slightly absorbent in the visible region. Niobium pentoxide Nb₂O₅, which has a refractive power of approximately 2.35, has a similar property.

It is mostly zirconium oxide ZrO₂ or tantalum pentoxide Ta₂O₅ that are used as transparent and thermally stable high refractive material in alternating layer systems. However, these two materials that are otherwise well suited for cold light mirrors subjected to high thermal loads have the disadvantage that their refractive power is much lower than that of titanium oxide at approximately 2.05 to 2.15. Consequently, an interference layer system will require many more alternating layers made from ZrO₂ and SiO₂ or from Ta₂O₅ and SiO₂, in order to attain the same properties of the spectral curves as in an alternating layer system made from TiO₂ and SiO₂, and this has a disadvantageous effect on the coating costs of the reflectors.

Consequently, systems having different advantages and disadvantages are available for coating the reflectors. In general, a high temperature stability entails high production costs, and this is particularly important for larger reflectors.

The present invention is therefore based on the problem of being able to use the advantages of specific basic materials and coatings for reflectors, and yet achieving acceptable production costs.

In order to achieve this object, according to the invention a high performance luminaire of the type mentioned at the beginning is characterized in that the reflector comprises at least a first partial reflector and a second partial reflector which lie next to one another at an abutting edge, and whose reflecting surfaces together form the internal reflecting surface of the reflector.

The inventive reflector for a high performance luminaire is therefore constructed in at least two parts. The invention therefore permits the production of the partial reflectors in conjunction with different requirement profiles for the partial reflectors which can, for example, result in the fact that one of the partial reflectors is arranged closer to the lamp used than is the other, or another, partial reflector. It is therefore possible, for example, from the point of view of thermal loading to design a highly thermally loaded region of the reflector as a first partial reflector, and a less highly thermally loaded region as a second partial reflector.

The second partial reflector can then differ from the first partial reflector with reference to the basic material and/or the coating. Thus, for example, a highly thermally loaded partial reflector whose surface constitutes only a relatively small fraction of the total surface of the reflector can be formed from an expensive basic material and an expensive coating, whereas at least one further partial reflector has a coating that can be produced more inexpensively, and/or a less expensive basic material that need not be capable of subjection to such high thermal loads.

The inventive division of the reflector into at least two partial reflectors also enables the reflector to be adapted to other parameters such as, in particular, adaptations of shape, layer designs of the reflecting layer etc.

A preferred main application of the present invention consists in that the partial reflectors separated from one another by the abutting edge are exposed by the lamp to different average thermal loads. In this case, it is possible, for example, for the first partial reflector, which is highly thermally loaded, to be designed with a glass ceramic material as basic material and to be expensively coated in order to achieve on this region as well a high degree of transparency to the thermal radiation. On the other hand, the second partial reflector can, for example, be formed from a borosilicate glass as basic material and can have a coating that is less expensive to produce and need not meet the highest demands with reference to thermal loading. Of course, it is also possible here to conceive of other variants. Thus, for example, it is possible to produce all the partial reflectors from the same basic material and, if appropriate, to provide them with various coatings. In individual cases, it can even be sensible to assemble the two reflectors from the same basic material and with the same coatings in relation to the reflector, because it is thereby possible to produce them in an improved fashion because of a specific shaping.

The present invention is important, in particular, for a reflector which has an internal reflecting surface increasing in a longitudinal direction. It is expedient in this case that the partial reflectors lying next to one another at the abutting edge adjoin one another in the longitudinal direction, that is to say the abutting edge runs transverse to the longitudinal direction. In this case, the abutting edge need not form a continuous contour, but can be shaped as desired. For example, the abutting edge can have projections and recesses, for example in a zigzag design, in order for the partial reflectors to be placed against one another at the abutting edge in a fashion which fits and is fixed against rotation. The abutting edge should preferably form a closed line.

In a particular embodiment of the invention, the reflector has an opening for the penetration of the lamp and has a cross section increasing beyond the lamp starting from the opening. According to the invention, the first partial reflector is arranged in this case around the opening, and the second partial reflector adjoins the first partial reflector in the direction of the increasing cross section. The first partial reflector is in this case preferably designed with regard both to the basic material and to the coating to be capable of higher thermal loading than the second partial reflector.

The internally reflecting surfaces in the partial reflectors should adjoin one another at the abutting edge with as little transition as possible, that is to say should form only a minimum gap which is not important optically. In order to enable this, and to enable the two reflective surfaces to be positioned accurately relative to one another, it is expedient when the partial reflectors adjoin one another at the abutting edge with complementary edges which are toothed over the thickness of the partial reflectors. The toothing, which can, for example, be designed in the manner of a groove and tongue connection, is intended in this case to permit a fitting assembly of the partial reflectors in such a way as to ensure accurate positioning in the direction that is radial with reference to a longitudinal axis. The partial reflectors are preferably held against one another by fastening means engaging over the abutting edge on their outside, the fastening means pressing the partial reflectors against one another, particularly with prestressing, that is to say are designed as clamping means, for example.

In a preferred embodiment of the invention, the first partial reflector, which can be a partial reflector capable of high thermal loading, has a reflecting surface which constitutes less than half, preferably less than a third, of the reflecting surface of the overall reflector.

The coatings of the partial reflectors can—as mentioned above—be of identical or different design. In particular, the coatings can also be applied using identical or different coating methods. This holds, in particular, when it is necessary to make use for the thermally more highly loaded first partial reflector of an expensive coating which can be avoided for the (larger) second partial reflector. The coatings of the partial reflectors are, in particular, interference optical coatings which enable the thermal radiation to be transported away from the useful beam path.

In particular applications, it can be expedient for at least one of the partial reflectors to have a faceting of its internal reflecting surface. Such facetings are customary in order, for example, to achieve a homogeneous distribution of the light of the lamp in an expanded beam. When the partial reflectors all have a faceting of the internal surface, this can be designed so as to produce a uniform faceting over the entire reflecting surface. In individual cases, it can be advantageous when the partial reflectors have unlike facetings.

The invention is to be explained in more detail below with the aid of an exemplary embodiment illustrated in the drawing, in which:

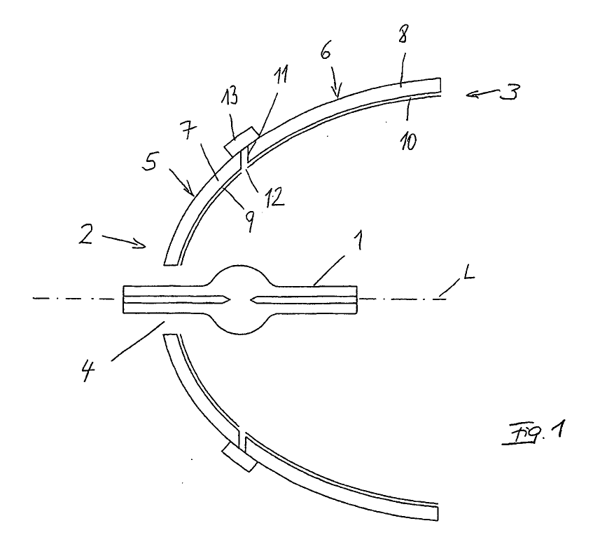

FIG. 1 shows a schematic sectional illustration of an embodiment of an inventive high performance luminaire;

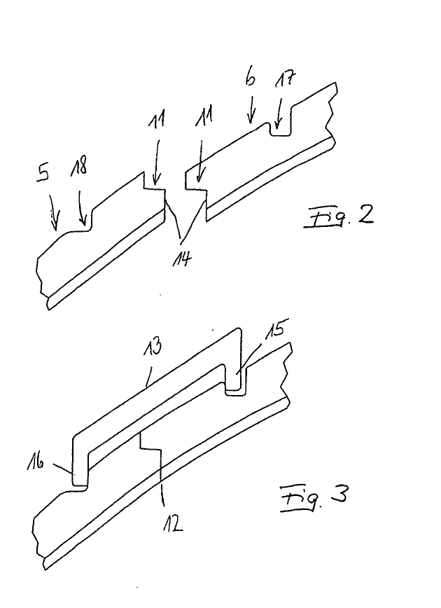

FIG. 2 shows a schematic detailed illustration for a toothed abutting edge at mutually separated partial reflectors;

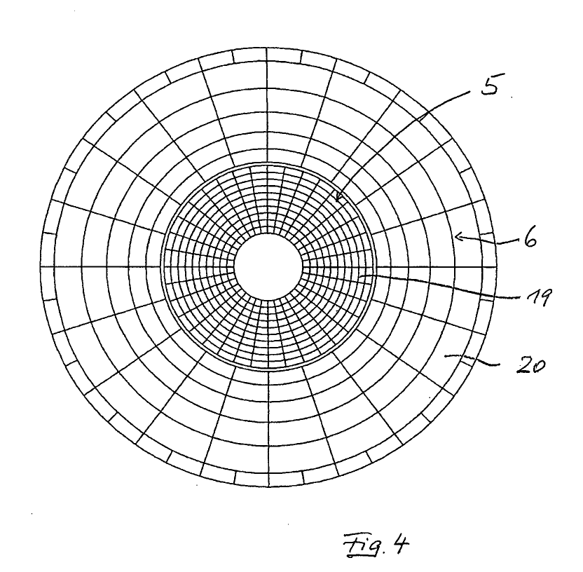

FIG. 3 shows an enlarged schematic illustration of the joined partial reflectors from FIG. 2; and

FIG. 4 shows a frontal plan view of a reflector formed from two partial reflectors with different facetings.

FIG. 1 shows a high performance luminaire which has a lamp 1 in the form of a very high pressure mercury lamp. The lamp 1 has a longitudinal axis L which forms an axis of symmetry of a reflector 2 whose internal surface 3 constitutes a three-dimensional closed surface which has in section the shape of a conical section (parabola, ellipse) or a free shape. The reflector 2 has a through opening 4 through which the lamp 1 projects into the interior of the reflector 2 in order to be electrically connected on the outside of the reflector 2.

In the exemplary embodiment illustrated, the reflector 2 comprises two partial reflectors 5, 6 that respectively consist of a basic material 7, 8 and an inner reflecting surface 9, 10 in the form of a coating, preferably of an interference optical coating. The two partial reflectors 5, 6 are placed against one another with abutting edges 11, and form a gap 12 there which is kept as small as possible with the aid of a fastening means 13 which engages over the abutting edges 11 on the outside of the reflector 2.

The first partial reflector 5 has the opening 4 and extends a little in the longitudinal direction L of the lamp 1 from the opening 4 with an ellipsoidal or paraboloidal shape. The second partial reflector adjoins the first partial reflector 5 in the longitudinal direction. Since the internal surface 3 of the overall reflector expands continuously in the longitudinal direction L from the opening 4, the second partial reflector 6 has a greater spacing from the lamp 1 than does the first partial reflector 5. This means that the second partial reflector 6 is subjected to less of a load by the thermal radiation than is the first partial reflector 5.

Consequently, it can be provided in accordance with the invention that the first partial reflector 5 consists of a basic material 7 made from glass ceramic, while the second partial reflector 6 can have a basic material 8 made from a borosilicate glass. In a similar way, the internal reflecting surface 9 of the first partial reflector 5 can consist of materials (ZrO₂ or Ta₂O₅ as high refractive material) which can be subjected to high thermal loads and require a higher number of layers than do more highly reflecting materials (for example TiO₂) which cannot be so highly loaded and can be suitable for the internal reflecting surface 10 of the second partial reflector 6.

FIG. 2 makes clear that the abutting edges 11 of the first partial reflector 5 and the second partial reflector 6 can have a complementary zigzag shape over their thickness (material strength) by means of which the two partial reflectors 5, 6 can be assembled with an accurate fit and the formation of a minimum gap 12, as is illustrated in FIG. 3. FIG. 3 also makes clear that the two partial reflectors 5, 6 are held together, with their abutting edges 11 lying against one another, by the fastening means 13 which engages with latching webs 15, 16 in appropriately provided cutouts 17, 18 in the partial reflectors 5, 6, and thus effects at the abutting edge 11 a prestressing which presses the two partial reflectors against one another and minimizes the width of the gap 12.

FIG. 4 shows in a frontal plan the partial reflectors 5, 6 whose surfaces are designed with different facets 19, 20. The faceting of the internal first partial reflector 5 in this case has smaller facets 19 than does the outer second partial reflector 6. It is evident to the person skilled in the art that both the size and the shape of the facets 19, 20 can be adapted to the respective illumination task, and that the internal surface of a partial reflector 5, 6 can also have different shapes and sizes of facets 19, 20 in order to achieve a desired beam shaping.

The inventive division of the reflector into partial reflectors 5, 6 whose internal surfaces 9, 10 adjoin one another to form the internal reflecting surface of the overall reflector enables an adaptation to the requirements made of the reflector in conjunction with an optimization of the production costs, since the majority of the overall reflector, formed here by the second partial reflector 6, can be produced cost effectively, while the first partial reflector 5 is designed for the high thermal loading owing to the lamp 1.

1. High performance luminaire having at least one lamp and a reflector, partially surrounding the lamp, for focusing to a directed beam the light emitted by the lamp, the reflector having an internal reflecting surface which includes regions with different requirements because of being differently spaced from the lamp, characterized in that the reflector comprises at least a first partial reflector and a second partial reflector which lie next to one another at an abutting edge, and whose reflecting surfaces together form the internal reflecting surface of the reflector.

2. High performance luminaire according to claim 1, characterized in that the partial reflectors separated from one another by the abutting edge are exposed by the lamp to different average thermal loads.

3. High performance luminaire according to claim 1, in which the reflector has an internal reflecting surface increasing in a longitudinal direction, characterized in that the partial reflectors lying next to one another at the abutting edge adjoin one another in the longitudinal direction.

4. High performance luminaire according to claim 1, characterized in that the abutting edges form a closed line.

5. High performance luminaire according to claim 1, in which the reflector has an opening for the penetration of the lamp and has a cross section increasing beyond the lamp starting from the opening, characterized in that the first partial reflector is arranged around the opening, and in that the second partial reflector adjoins the first partial reflector in the direction of the increasing cross section.

6. High performance luminaire according to claim 1, characterized in that the partial reflectors adjoin one another with complementary abutting edges which are toothed over the thickness of the partial reflectors.

7. High performance luminaire according to claim 6, characterized in that the partial reflectors adjoin one another in the manner of a groove and tongue connection.

8. High performance luminaire according to claim 1, characterized in that the surfaces of the partial reflectors adjoin one another continuously.

9. High performance luminaire according to claim 1, characterized in that the partial reflectors are held against one another by fastening means engaging over the abutting edges on their outside.

10. High performance luminaire according to claim 9, characterized in that the fastening means press the partial reflectors against one another with prestressing.

11. High performance luminaire according to claim 10, characterized in that the fastening means are designed as latching means.

12. High performance luminaire according to claim 1, characterized in that the first partial reflector has a reflecting surface that constitutes less than half the reflecting surface of the overall reflector.

13. High performance luminaire according to claim 12, characterized in that the reflecting surface of the first partial reflector constitutes less than a third of the reflecting surface of the overall reflector.

14. High performance luminaire according to claim 1, characterized in that the reflecting surfaces of the partial reflectors are formed by preferably multilayer coatings.

15. High performance luminaire according to claim 14, characterized in that the coatings of the partial reflectors are differently constructed with reference to their materials.

16. High performance luminaire according to claim 14, characterized in that the coatings of the partial reflectors are identically constructed with reference to their materials.

17. High performance luminaire according to claim 14, characterized in that the coatings of the partial reflectors are applied using different coating methods.

18. High performance luminaire according to claim 14, characterized in that the coatings of the partial reflectors are applied using identical coating methods.

19. High performance luminaire according to claim 1, characterized in that the first partial reflector has a basic body made from a glass ceramic material with a coating forming the reflecting surface.

20. High performance luminaire according to claim 1, characterized in that the second partial reflector has a basic body made from a glass, in particular silicate glass, with a coating forming the reflecting surface.

21. High performance luminaire according to claim 14, characterized in that the partial reflectors have interference optical coatings as reflecting surfaces.

22. High performance luminaire according to claim 1, characterized in that at least one of the partial reflectors has a faceting of its internal reflecting surface.

23. High performance luminaire according to claim 22, characterized in that the partial reflectors have an identical faceting.

24. High performance luminaire according to claim 22, characterized in that the partial reflectors have unlike facetings.
